(19) United States
(12) Patent Application Publication
(10) Pub. No.: US 2023/0347416 A1
(43) Pub. Date: Nov. 2, 2023

(54) ADDITIVE MANUFACTURING ON A TURBINE ENGINE PART BLANK INCLUDING A ROUGH AREA

(71) Applicant: SAFRAN AIRCRAFT ENGINES, Paris (FR)

(72) Inventors: Pierre Jean-Baptiste METGE, Moissy-Cramayel (FR); Guilhem Kevin COMBES, Moissy-Cramayel (FR); Alexandre CORSAUT, Moissy-Cramayel (FR)

(73) Assignee: SAFRAN AIRCRAFT ENGINES, Paris (FR)

(21) Appl. No.: 18/245,384

(22) PCT Filed: Sep. 15, 2021
(86) PCT No.: PCT/FR2021/051580

§ 371 Date: Mar. 15, 2023

(30) Foreign Application Priority Data
Sep. 16, 2020 (FR) 2009369

(51) Int. Cl. B22F 12/30; B33Y 30/00; B22F 10/47; B33Y 10/00; B22F 10/28; B33Y 40/10

(52) U.S. Cl. CPC B22F 12/30; B33Y 30/00; B22F 10/47; B33Y 10/00; B22F 10/28; B33Y 40/10; B22F 2998/10

(57) ABSTRACT

A production of a structure for a turbomachine by additive manufacturing, including the following steps: a) providing an element having at least one localised rough region, in particular produced by machining, b) using powder bed fusion additive manufacturing in order to deposit a layer of material resulting from the fusion on the element.

### TECHNICAL FIELD

The present application relates to the field of additive manufacturing, and in particular that one using the technique of laser fusion on a powder bed.

More specifically, it relates to the additive making of parts for turbine engines.

### PRIOR ART

Powder bed selective fusion or selective sintering processes allow making metal or ceramic parts with complex shapes which are subjected to significant mechanical and/or thermal constraints such as turbine engine parts.

In particular, such processes are known by the acronyms SLM (standing for “Selective Laser Melting”), SLS (standing for “Selective Laser Sintering”), DMLS (standing for “Direct Metal Laser Sintering”) and EBM (standing for “Electron Beam Melting”).

In general, these processes comprise a step of depositing a powder layer, followed by a step of heating a predefined area of the powder layer by a laser beam or by an electron beam. The energy supplied by this beam causes the local melt-down or the local sintering of the powder which, when solidifying, forms a layer of the part.

Such techniques imply that each layer is supported by the previous one. That is why making of such parts having significant cantilevers is problematic.

To make a part with a significant cantilever, in particular when an area of the part forms an angle smaller than 45° with respect to a manufacturing tray on which it rests, a known solution consists in supporting this area by means of a support, which may be temporary and removed once all layers have been formed.

In the example illustrated in FIG. 1A, a blank 2 of a part that is to be made by additive manufacturing includes a region 2A forming an angle for example in the range of 30° with a plane parallel to a main plane of a tray 8 over which this element is located.

In FIG. 1B, a temporary support 4 is herein placed over a horizontal area 2B disposed opposite the cantilevered region 2A. The support 4 may also serve in dissipating the heat and preventing inadvertent deformations of the part 2.

In some cases, if the support 4 is not held in a stable manner during manufacture, a breakage of the support could happen. In particular, the connection between the root 4A of the support and the skin of the part on which the support bears might break up during manufacture. This could make carrying on the manufacture of the part impossible.

The problem of finding a new additive manufacturing process, in particular for making turbine engines, that is improved with regards to the aforementioned drawback(s) arises.

### DISCLOSURE OF THE INVENTION

According to one aspect, an embodiment of the present invention provides a part or structure element, also called “blank”, for the additive manufacturing of a part or a structure, said element or said blank being provided with at least one localised rough region.

The localised rough region may allow improving hooking of a support serving as a mechanical support during the additive manufacturing method. The rough region may also allow limiting the amount of reflected energy of the laser radiation on other portions of the part or of the structure during the additive manufacturing method.

Advantageously, the rough region may be formed by a series of serrations and/or protrusions and/or grooves.

The distribution of patterns forming the rough region may be regular, for example according to a straight or cross knurling or according to concentric lines.

The localised rough region may be formed by machining or by addition of material.

According to a possible implementation, the localised rough region is formed or located in a portion made of a ceramic material or of a metal alloy of said element, in particular a Titanium- or Nickel-based one.

Several distinct localised rough regions may be provided for on the same part or structure element or blank.

According to a particular embodiment, the blank may be part or be intended to be part of an aircraft turbine engine part or of a structure for an aircraft turbine engine, for example a stator or low-pressure distributor sector.

According to another aspect, the present invention relates to a device for additive manufacturing of a part of a turbine engine or of a structure for a turbine engine, comprising:
a part or structure element as defined hereinabove,
a manufacturing support, said manufacturing support being disposed over and in contact with said rough region.

The part or structure element and the support may be arranged on a tray, said manufacturing support being disposed under and in contact with a portion of said element, in particular forming an angle smaller than 45° with respect to a plane parallel to the main plane of said tray.

According to another aspect, the present invention relates to a system for powder bed fusion additive manufacturing comprising a device as defined hereinabove.

According to another aspect, the present invention also relates to a method for additive manufacturing of a part of a turbine engine or of a structure for a turbine engine, comprising the following steps:
a) providing blank or a device as defined hereinabove,
b) depositing by additive manufacturing in particular by laser fusion on a powder bed, at least one material layer resulting from said fusion over said element.

Advantageously, prior to step a), the method comprises the formation of said localised rough region on said blank by machining.

### BRIEF DESCRIPTION OF THE DRAWINGS

The present invention will be better understood in light of the following description and the appended drawings wherein:

FIGS. 1A, 1B are intended to illustrate a part or structure blank and a support for the implementation of a method for additive manufacturing of said part or of said structure;

FIGS. 2A, 2B are intended to illustrate a blank including at least one localised rough region as implemented according to the invention and a support for the implementation of a method for additive manufacturing of a part or structure on this blank;

FIGS. 3A, 3B are intended to illustrate a first example of a rough region including serrated patterns;

FIGS. 4A, 4B are intended to illustrate a second example of a rough region including pyramidal pointed patterns;

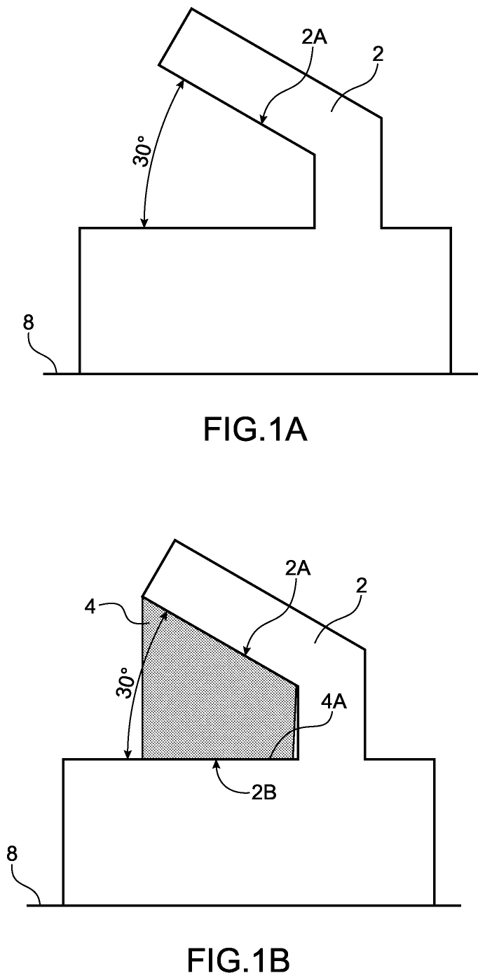

Identical, similar or equivalent portions of various figures bear the same numerical references such as to facilitate the change from one figure to the other.

The various portions shown in the figures are not necessarily according to a uniform scale, in order to make the figures more readable.

### DETAILED DISCLOSURE OF PARTICULAR EMBODIMENTS

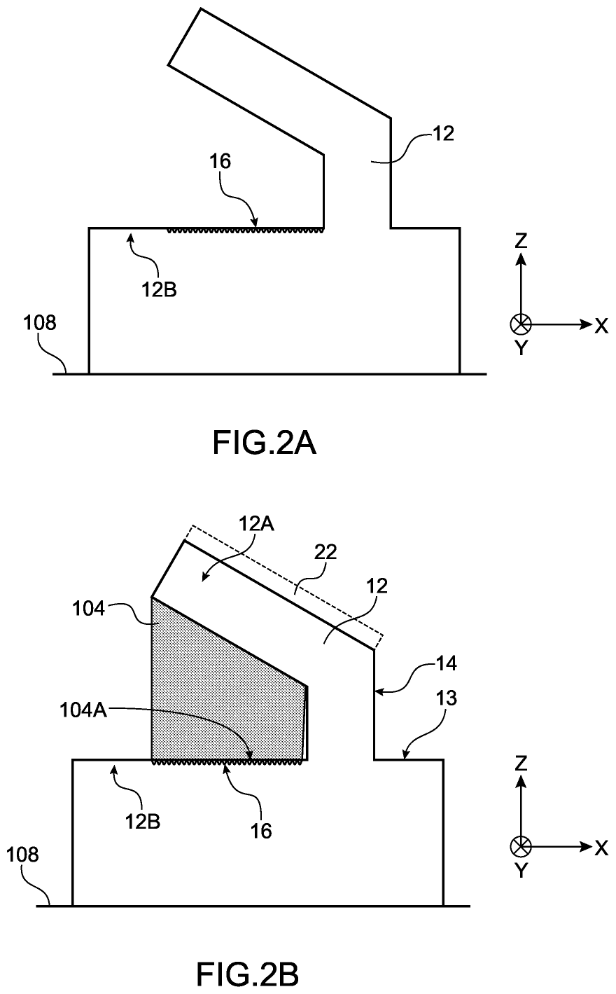

FIGS. 2A-2B give an example of an element 12 also called “blank” over an addition of material 22 is to be carried out by additive manufacturing to manufacture a mechanical part or a structure and which is arranged over a movable manufacturing tray 108 in particular relative to a material supply source (not represented).

In particular, the targeted additive manufacturing technique may be a powder bed fusion technique where a laser is used to selectively make powder particles, in particular metal powders, melt down while binding them together to build the mechanical part layer-by-layer.

The part element 12 is herein particular in that it has a portion 12B provided with at least one first localised rough region 16. This localised rough region 16 is herein intended to be in contact with a support 104 or is provided with an area intended to receive a support 104 configured to support, during the manufacture of the part or of the structure, another portion 12A having a cantilevered arrangement. In particular, the support 104 may be a cellular support, i.e. provided with cavities.

Preferably, the roughness of the region 16 has been formed intentionally and may for example be in the form of a corrugation or of a predetermined irregular profile provided for during the design of the element 12.

The rough region 16 may allow obtaining a better hooking of the support 104 and ensuring holding of the latter in position during the addition of layers by additive manufacturing.

The portion 12B on which the region for receiving the support 104 is located may in particular be a “horizontal” portion 104A over which the support 104 is disposed. By “horizontal portion”, it should be understood a portion parallel to a main plane of the tray 108, the main plane of the tray 108 being a plane passing through the latter and parallel to the plane [O; x; y] given in FIGS. 2A-2B.

In this particular configuration where the support 104 does not rest directly on the tray 108 but on a portion 12B of the blank 12 itself, providing a rough manufacturing tray is not enough for enabling a stable holding of the support 104.

In particular, the rough region 16 of the element 12 has an arithmetic average corrugation parameter Wa corresponding to the arithmetic average corrugation of its profile or an arithmetic average roughness parameter Ra corresponding to the arithmetic average roughness of its profile which is greater than the rest of the portion 12B or at least than other areas 13, 14 of the part. Typically, the rough region 16 has a parameter Ra or Wa greater than 100 microns, whereas the other areas 13, 14 around this rough region 16 have an average roughness or a corrugation parameter that is lower, and which may be comprised between 1 and 30 microns.

The roughness of the region 16 may be a signature of a machining type. Various techniques can be used to form this roughness. A projection method using abrasive elements, such as a bead projected at high speed, may possibly be used. Alternatively, it is possible to perform a structuring by means of at least one sharp or cutting tool or by pressing.

Nonetheless, preferably, the roughness of the region 16 is obtained by addition of material.

The roughness may be in different forms.

According to one embodiment, the roughness may be provided with regular patterns such as furrows, possibly distributed according to a given periodicity. A straight or cross knurling or a knurling according to concentric curved lines may also be implemented. It is possible to prefer the formation of a roughness requiring adding a small volume of material. Typically, a knurling meets this criterion.

According to a possible implementation, the rough region is formed by ridges or furrows or a series of faces with different inclinations. Alternatively, it may have the appearance of repeated and in particular sharp protrusions for example conical shaped. In particular, the roughness may be formed by patterns (ridges or spikes) arranged in a regular manner, for example in parallel rows or in parallel curved lines, or according to a matrix of patterns spaced apart according to a determined step. Preferably, to form the roughness, patterns are provided for allowing reducing the bearing surface at the root 104A of the support 104 in order to less pollute the part and to reduce the support volume.

The patterns may have a maximum dimension D_{M} (dimension that is neither the thickness nor the height) in the range of one or more millimetre(s), typically between 1 and 10 mm, preferably between 2 and 4 mm. For example, in the case of patterns in the form of conical spikes, the maximum dimension D_{M} corresponds to the diameter of the base of the cone. According to another example, in the case of patterns in the form of pyramids, the maximum dimension D_{M} corresponds to the side of the base of the pyramid. In the case of patterns in the form of protrusions, in particular sharp protrusions such as cones or pyramids, these protrusions may have a height H in the range of one or more millimetre(s), typically between 0.5 mm and 5 mm, preferably between 1 mm and 2 mm.

A part or structure element as implemented according to the invention may include several distinct localised rough regions. For example, the blank 12 may include another rough region at the portion 12A.

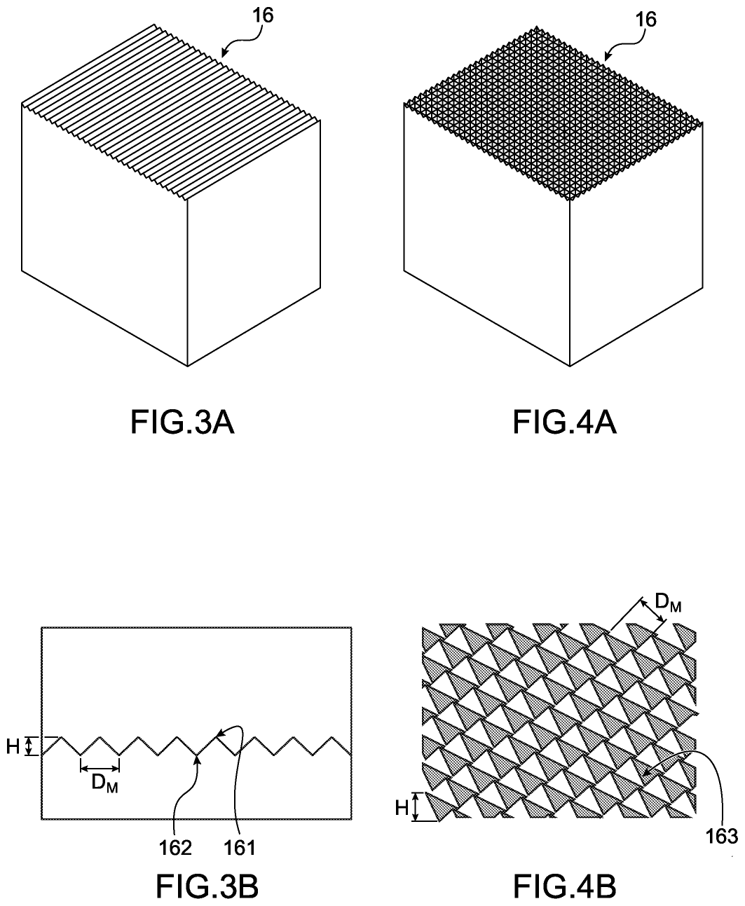

Different examples of patterns allowing forming the rough region 16 are given in FIGS. 3A-3B and 4A-4B.

In the particular embodiment illustrated in FIGS. 3A-3B, the rough region 16 is in the form of a serrated surface formed by a series of serrations 161, for example triangular shaped, which are parallel and separate from each other by grooves 162.

Another example of a rough region is given in FIGS. 4A-4B, this time with a rough surface formed by a meshing of pyramid-shaped micro-points 164.

The blank 12 as well as the part or structure that is to be manufactured may be made of a ceramic material or of a metal alloy such as a TiAl alloy or, according to another example, a superalloy based on Nickel and one or more of the following elements: Cr, Co, Mo, W, AI, Ti, Ta, Hf, Re, Ru.

The rough region 16, in particular when it includes a portion unveiled upon exposure to laser may also allow limiting a laser reflection phenomenon which might be at the origin of overheating and make some portions of the part fragile.

Thus, as a variant of the previously-described embodiment, one might wish to perform the material addition directly over a localised rough region of the blank, in particular of a blank that could serve as a support element to another portion of a structure or of a part that is made by additive manufacturing on this blank.

According to a particular application, at least one localised rough region is provided for of the type as the previously-described on a part or structure element for the additive manufacturing of a turbine engine part or of a structure for a turbine engine.

In particular, the rough region may be formed for example on the support of a stator or distributor sector or else on a support root of a frame sector.

Structures other than frames or distributors or vane sectors can be made by means of a rough blank as implemented according to the invention and the present invention thus has numerous applications.

1-7. (canceled)

8. A device for additive manufacturing of a part of a turbine engine or of a structure for a turbine engine, comprising:
a manufacturing support, for additive manufacturing of a part of a turbine engine or of a structure for a turbine engine,
a part element, forming a blank of a turbine engine part or a blank of a structure for a turbine engine, said element being provided with at least one localised rough region, said rough region having an arithmetic average corrugation parameter Wa corresponding to the arithmetic average corrugation of its profile or an arithmetic average roughness parameter Ra corresponding to the arithmetic average roughness of its profile which is greater than 100 microns,
wherein, for the manufacture of said part or of said structure by additive manufacturing, said manufacturing support is disposed over and in contact with said rough region of said part element.

9. The device according to claim 8, wherein said element and said support are arranged on a tray, said manufacturing support being disposed under and in contact with a portion of said element, in particular a portion forming an angle smaller than 45° with respect to a plane parallel to the main plane of said tray.

10. The device according to claim 8, said localised rough region being formed by a series of serrations and/or protrusions and/or grooves and/or corrugations.

11. The device according to claim 8, said localised rough region being formed in a portion made of metal alloy of said element, in particular a Titanium- or Nickel-based alloy.

12. The device according to claim 8, wherein the manufacturing support is a cellular support provided with cavities.

13. A system for powder bed fusion additive manufacturing comprising a device according to claim 8.

14. A method for additive manufacturing of a part of a turbine engine or of a structure for a turbine engine, the method comprising the following steps:
a) providing a device according to claim 8,
b) depositing by additive manufacturing in particular by powder bed fusion, a material layer resulting from said fusion over said element.

15. The method according to claim 14, further comprising, prior to step a), the formation of said localised rough region on said element by machining.
